(19) United States
(12) Patent Application Publication
(10) Pub. No.: US 2011/0216927 A1
(43) Pub. Date: Sep. 8, 2011

(54) Hearing System

(75) Inventor: Geoffrey R. Ball, Axams (AT)

(73) Assignee: VIBRANT MED-EL HEARING TECHNOLOGY GMBH, Innsbruck (AT)

(21) Appl. No.: 13/038,825

(22) Filed: Mar. 2, 2011

Related U.S. Application Data
(60) Provisional application No. 61/309,632, filed on Mar. 2, 2010.

(51) Int. Cl. H04R 25/00

(52) U.S. Cl. 381/313; 381/321

(57) ABSTRACT

A hearing system for use by a user is presented. The hearing system includes an external portion for placement external the user. The external portion includes a sound processing unit for providing amplified acoustic sound to an ear of the user. The hearing system further includes an implantable portion for implantation under the skin of the user. The implantable portion and the sound processing unit have magnetic characteristics such that a magnetic attraction exists there between to retain the sound processing unit in a desired position.

### CROSS-REFERENCE TO RELATED APPLICATIONS

This application claims priority to U.S. Provisional Patent Application No. 61/309,632 filed Mar. 2, 2010, which is hereby incorporated by reference herein in its entirety.

### TECHNICAL FIELD

The present invention relates to a hearing system, and more particularly, to an acoustic sound processing unit held in position with one or more implanted magnets.

### BACKGROUND ART

Acoustic hearing aids have been known in the field for many years. The modern hearing aid was invented by G. H. Collins in 1898 and featured a device including a battery, signal processor, microphone, amplifier and a speaker (receiver) placed in the ear canal. The hearing aids of today, though vastly improved over the devices conceived by Mr. Collins, still rely on essentially the same functional blocks.

A number of inventions have described the various configurations of hearing aids and improvements to the microphone, speaker (receiver) and signal processing electronics. Numerous inventions relating to the insertion of the device have also been described. For example, some of the devices described cover new ways to place devices into the ear canal (e.g., one size fits all, or custom ear molds). However, since the 1950's, as electronics have improved and made hearing aids smaller, the acoustic hearing aid still typically uses some portion of the external ear to support the external electronics and sound delivery units of the hearing aid.

Exemplary types of current hearing aid configurations include Behind the Ear (BTE) devices, In the Ear (ITE) devices, and Completely in the Canal (CIC) devices. BTE devices include a plastic hearing aid where the electronics unit, power supplies and microphone are worn behind the Pinna of the external ear. A custom plastic ear mold with plastic tubing connects to the BTE unit and is worn in the patient's external ear canal.

ITE devices are typically custom units where an impression of the patients ear canal is made that is molded into a device worn within the concha region of the patient's ear. The electronics are imbedded within a plastic custom housing unit.

A CIC device 103 is shown in FIG. 1 (prior art). CIC devices typically have a plastic custom housing that encompasses all the electronics and is worn completely in the ear canal 105. These devices are arguably the smallest of the hearing aids made today.

Ironically, one hundred years after Mr. Collins invented the acoustic electronic hearing aid, today less than 10% of persons who suffer from hearing loss own a hearing aid and of those that do own one many wear it occasionally. Although many would argue that sound quality is a main problem with hearing aids, other reasons are often just as significant and include: feedback, chronic discomfort (in some cases pain) caused by the hearing aid; occlusion (an unnatural hollow sound quality caused when a hearing aid completely fills the outer part of the ear canal); cosmetics; and ease of use.

Alternative “direct drive” hearing devices have also been suggested. Instead of using acoustic sound to drive the tympanic membrane, such devices directly drive some portion of the ear with a small transducer that is implanted and/or attached to the middle ear 108. Although studies have shown that direct drive hearing devices have superior results for many types of hearing loss over conventional hearing aids, the cost of these devices is high and surgery is required. In many cases, for people who cannot or refuse to wear hearing aids, alternatives such as direct drive devices are often the only available option.

### SUMMARY OF THE INVENTION

In accordance with an embodiment of the invention, a hearing system for use by a user is presented. The hearing system includes an external portion for placement external the user. The external portion includes a sound processing unit for providing amplified acoustic sound to an ear of the user. The hearing system further includes an implantable portion for implantation under the skin of the user. The implantable portion and the sound processing unit have magnetic characteristics such that a magnetic attraction exists there between to retain the sound processing unit in a desired position.

In accordance with related embodiments of the invention, the implantable portion may include a magnet. The magnet may be hermetically sealed for example, in a titanium laser welded can. The sound processing unit may include a magnet. The implantable portion may include a first and second magnet positioned so as to have reverse polarity when the implantable portion faces the sound processing unit. The implantable portion and/or the sound processing unit may include a magnetic material, such as stainless steel, that is attracted to a magnet.

In accordance with further related embodiments of the invention, the sound processing unit may include a microphone. The microphone may be a directional microphone and/or an omnidirectional microphone. The directional microphone may include an inlet at a first end of the microphone, and a plurality of evenly spaced diffusion ports along the length of the microphone. The directional microphone may include a transducer operationally coupled to a second end of the microphone, the transducer for converting acoustic energy into an electrical signal proportional to sound. The transducer may be an electret type microphone transducer. The directional microphone may be a shotgun microphone. The shotgun microphone may have a sound input port having a length of between 3 and 8 cm, and an outer diameter between 0.5 and 5 mm. The microphone may be removable coupled to the sound processing unit. The sound processing unit may include a switch between omnidirectional and directional modes.

In accordance with still further related embodiments of the invention, the external portion may include a sound tube, the sound tube channeling amplified acoustic sound from the sound processing unit to the ear canal. The sound tube may be plastic and/or a polyvinyl. The sound tube may include a wax guard. The sound tube may have an inner diameter between substantially 0.25 mm and 1.5 mm.

In accordance with yet further related embodiments of the invention, the sound processing unit may includes a battery, the battery positioned at the bottom of the sound processing unit such that gravity promotes proper positioning of the sound processing unit. The battery is a zinc air type cell.

In accordance with even further related embodiments of the invention, the sound processing unit may be adapted to accommodate an ancillary device. The ancillary device may be a cell phone. The sound processing unit may include an interface for receiving at a FM signal, an AM signal, a blue tooth signal and/or a MP3 signal.

In accordance with yet further related embodiments of the invention, a hair clip for may facilitate placement of the sound processing unit. The hair clip may be magnetic. The hair clip may be made of a material attracted to a magnet, such as stainless steel. The hair clip may be a bayonet.

In accordance with another embodiment of the invention, a method of positioning a sound processing unit on a user is presented. The sound processing unit for providing amplified acoustic sound to an ear of the user. The method include placing the sound processing unit externally to the user such that there is a magnetic attraction between the sound processing unit and an implanted portion of the acoustic sound hearing system that is implanted under the skin of the user, so as to retain the sound processing unit in a desired position.

In accordance with related embodiments of the invention, placing the sound processing unit such that there is magnetic attraction between the sound processing unit and an implanted portion may include using a magnet associated with at least one of the implantable portion and the sound processing unit. The implantable portion may include a first and second magnet positioned so as to have reverse polarity when the implantable portion faces the sound processing unit. Placing the sound processing unit such that there is magnetic attraction between the sound processing unit and an implanted portion may include using a magnetic material.

In accordance with further related embodiments of the invention, the sound processor may converting an acoustic signal to an electric signal via a microphone. Amplified acoustic sound may be channeled from the sound processing unit to the ear canal via a sound tube. A battery may be positioned at the bottom of the sound processing unit such that gravity promotes proper positioning of the sound processing unit. The sound processing unit may interface with an ancillary device such as a cellphone, and/or include an interface to receive a phone signal, a FM signal, an AM signal, a blue tooth signal and/or a MP3 signal. A hair clip may be used to facilitate placement of the sound processing unit. The hair clip may include a magnet, stainless steel, and/or a bayonet. The implanted portion may be void of any electronic components.

### BRIEF DESCRIPTION OF THE DRAWINGS

The foregoing features of the invention will be more readily understood by reference to the following detailed description, taken with reference to the accompanying drawings, in which:

FIG. 1 shows a Completely in the Canal hearing aid device (prior art);

FIG. 2 shows an acoustic hearing aid system, in accordance with an embodiment of the invention;

FIG. 3(a) shows an implantable portion of the acoustic hearing aid system that may be screwed directly into the skull, in accordance with an embodiment of the invention. FIG. 3(b) shows an implantable portion of the acoustic hearing aid system that may be implanted via use of a support base that facilitates use of bone sutures, in accordance with an embodiment of the invention;

FIG. 4(a) shows screw(s) having magnetic properties that may serve as the implantable portion, in accordance with an embodiment of the invention. FIG. 4(b) shows magnets or magnetic material that may serve as the implantable portion which do not have attachment mechanisms, in accordance with an embodiment of the invention;

FIG. 5 shows an external portion of an acoustic hearing aid system, in accordance with an embodiment of the invention;

FIG. 6 shows an exemplary sound processor unit, in accordance with an embodiment of the invention;

FIG. 7 shows the positioning of the battery within a sound processing unit, in accordance with an embodiment of the invention;

FIG. 8 shows a sound processing unit held into place by an implantable portion of an acoustic hearing aid system, in accordance with an embodiment of the invention;

FIG. 9 shows an ear canal insert piece, in accordance with an embodiment of the invention;

FIG. 10 shows the sound processing unit positioned on a patient, in accordance with an embodiment of the invention;

FIG. 11 shows the sound processing unit positioned on a patient, in accordance with an embodiment of the invention;

FIG. 12 shows a bobbin insert that may be used in the embodiment shown in FIG. 11, in accordance with an embodiment of the invention;

FIG. 13 shows a sound processing unit that includes a hair trap, in accordance with an embodiment of the invention;

FIG. 14 shows a sound processing unit having a hair trap secured in position adjacent an implantable portion of an acoustic hearing aid system, in accordance with an embodiment of the invention; and

FIG. 15 shows various configurations of a sound tube and ear canal insert piece, in accordance with embodiments of the invention.

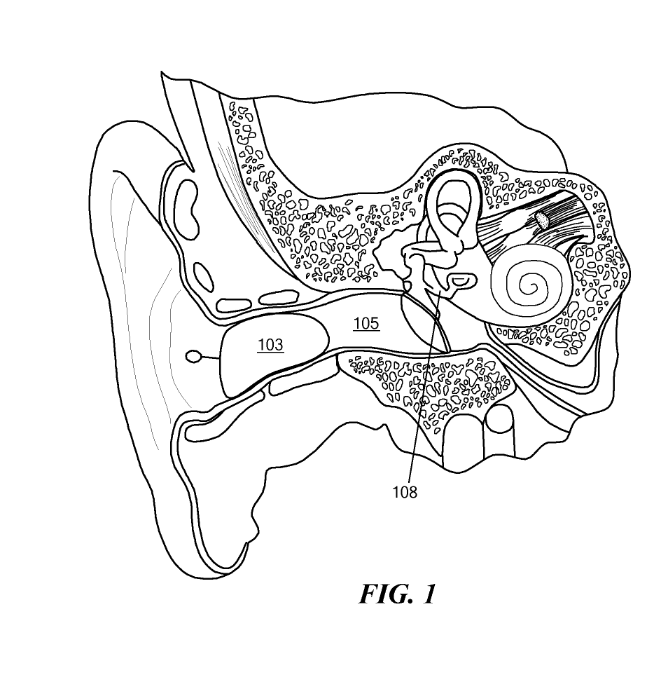

### DETAILED DESCRIPTION OF SPECIFIC EMBODIMENTS

In illustrative embodiments, a system and method of positioning a sound processing unit of an acoustic hearing aid system is provided. The system includes a magnetic implant for placing under the skin of a patient, which is used to hold in place the sound processing unit of the hearing aid system. The majority of the sound processing unit of the hearing aid system may be concealed, for example, under the hair of a patient. Principal advantages include, but are not limited to, improved cosmetic appearance, improved comfort, reduced feedback and reduced occlusion. Details are described below.

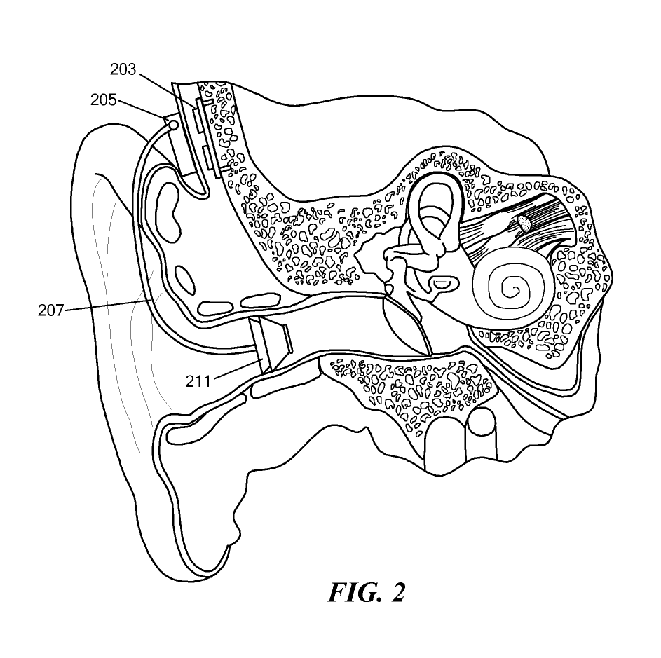

FIG. 2 shows an acoustic hearing aid system, in accordance with one embodiment of the invention. The system includes an external portion and an implantable portion. The external portion includes, without limitation, a sound processing unit 205, a sound tube 207 and an ear canal insert piece 211. The sound processing unit 205 receives acoustic sound, which may be amplified. An acoustic, amplified (or in other embodiments, non-amplified) signal is provided via the sound tube 207 to the ear canal insert piece 207 that is inserted in the ear canal of the patient.

The sound processing unit 205 is advantageously held in place on the patient, at least in part, by the implantable portion 203 of the acoustic hearing aid system. More particularly, the implantable portion 203 and the sound processing unit 205 exhibit magnetic characteristics such that a magnetic attraction exists there between to retain the sound processing unit 205 in a desired position. The implantable portion 203 may be, without limitation, implanted just under the skin of the patient, and positioned approximately 2-4 cm post-auricular (approximately 2-4 cm behind the ear). The correct positioning and/or orientation of the implantable portion 203 is often critical to correctly align the sound processing unit 205. For example, in various embodiments the microphones of the sound processing unit 205 must remain in a horizontal (or other) plane post-surgically for ideal performance to be realized. The surgery required to implant the implantable portion 203 may be done in less than 30 minutes by most surgeons, under a local anesthetic in an outpatient facility or a minor operating room.

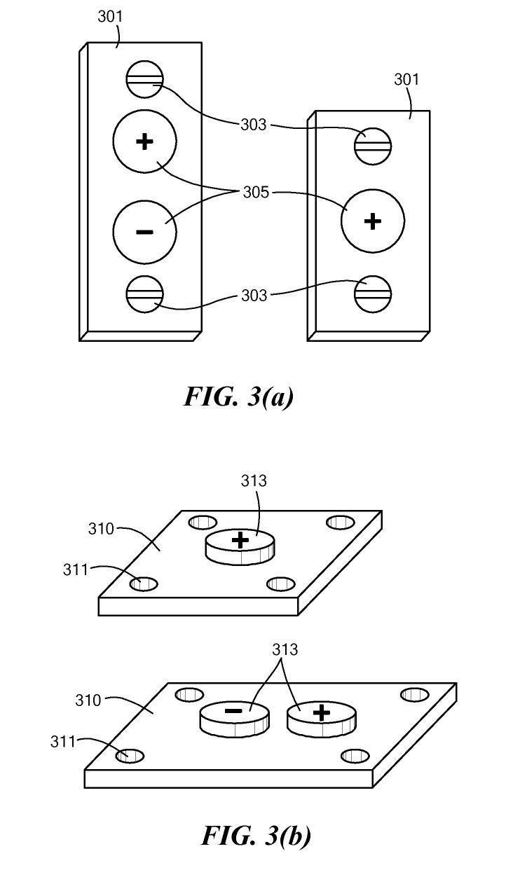

The implantable portion 203 of the acoustic hearing aid system may be, without limitation, screwed directly into the skull, sutured into the skull, or simply placed under the skin without attachment to the skull. FIGS. 3(a) and (b) show various embodiments of the implantable portion 203 of the acoustic hearing aid system in more detail. More particularly, FIG. 3(a) shows an implantable portion that includes a base 301 that may be screwed directly into the skull, in accordance with an embodiment of the invention. The base 301 includes thru holes into which bone screws 303 or other attachment mechanisms can be placed. The base 301 may be made of, without limitation, titanium. The base 301 may include a plurality of magnets 305 (FIG. 3(a), left embodiment), a single magnet 305 (FIG. 3(a), right embodiment) or no magnet but rather a material attracted to a magnet (not shown, see discussion below). The magnet(s), such as NdFeB or SmCo magnets, may be hermetically sealed, for example, in laser welded titanium cans. FIG. 3(b) shows an implantable portion having a base 311 that can be attached to the skull using sutures. Illustratively, a silicone support base 310 includes suture holes 311 that facilitate use of bone sutures during surgery. Again, the base 311 may include one (FIG. 3(b), top embodiment) or a plurality of magnets 313 (FIG. 3(b), bottom embodiment), or no magnet but rather a magnetic material.

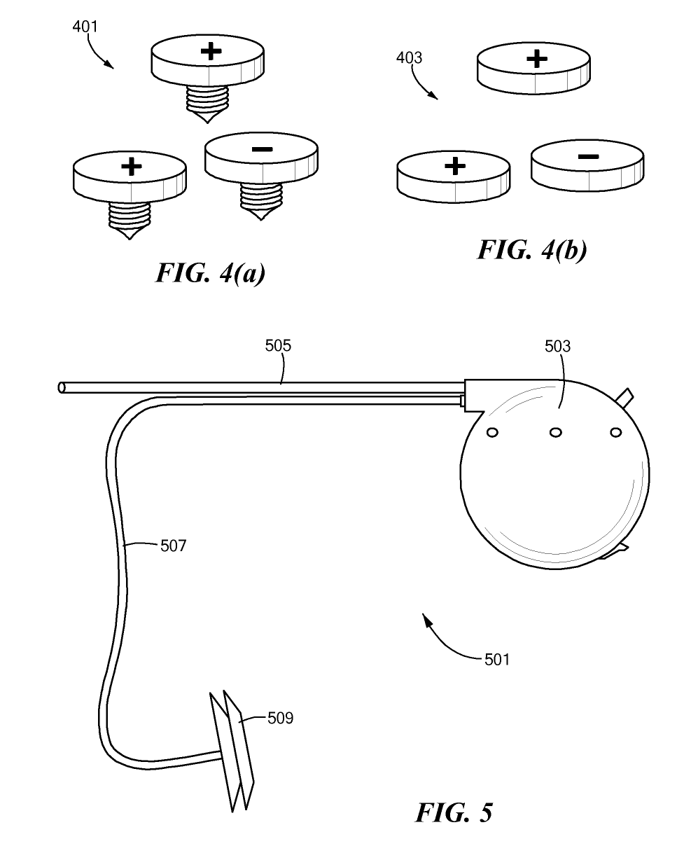

Instead of including a base, FIG. 4(a) shows screw(s) 401 having magnetic properties that may serve as the implantable portion, in accordance with an embodiment of the invention. The screws 401 may attach, without limitation, directly to the skull. The screws may be a magnet, or be made of a material that is attracted to a magnet. One or multiple screws 401 may be utilized. Attachment mechanisms other that screws 401 may be utilized, as known in the art. FIG. 4(b) shows magnets or magnetic material 403, which can serve as the implantable portion, and which do not have attachment mechanisms but are simply inserted underneath the skin, in accordance with an embodiment of the invention.

In various embodiments, the implantable portion 203 of the acoustic hearing aid system may include a magnet(s) that is capable of aligning itself with an external magnetic field, such as during Magnetic Resonance Imaging (MRI), as described in U.S. Pat. No. 6,838,963, U.S. Pat. No. 7,566,296, and U.S. Pat. No. 7,566,296, each of which is herein incorporated by reference in its entirety. Magnets of this type advantageously do not experience any torque as a result of an external magnet field, nor will they become demagnetized.

In various embodiments, the implantable portion 203 is void of any passive and/or active electronic components. Illustratively, the implantable portion may not include a coil for subcutaneous transfer of power.

Referring back to FIG. 2, while a magnet(s) may be placed in both the sound processing unit 205 and the implantable portion 203, in various embodiments only one of the sound processing unit 205 and the implantable portion 203 may include a magnet, with the other of the sound processing unit 205 and the implantable portion 203 including one or more materials attracted to the magnet. For example, the sound processing unit 205 may include a magnet(s), while the implantable portion 203 include stainless steel or other magnetic material. That the implantable portion 203 does not include a magnet may be advantageous, for example, to patients undergoing MRI examinations.

FIG. 5 shows an external portion 501 of an acoustic hearing aid system, in accordance with an embodiment of the invention. The external portion 501 includes a sound processor unit 502. The sound processor unit 502 may include one or more microphones 511 incorporated, for example, on the housing of the sound processor unit 503, which may be, without limitation, directional or omnidirectional microphones. The microphones 511 may be removably attached to the sound processor unit 503.

Attached to the sound processing unit 502 is a sound tube 507. Amplified acoustic sound is output from the sound processing unit 502 to the ear canal insert piece 509 via the sound tube 507. The length of the sound tube 507 may be determined by the anatomy of the patient and the location of the sound processor unit 502. The sound tube 507 may, without limitation, have an inner diameter of 0.25 to 1.5 mm. The sound tube 507 may have a wax guard. The sound tube 507 may be made of plastic, polyvinyl and/or other similar material, which may be, without limitation, clear. The ear canal insert piece 509 can vary in size from approximately 4-9 mm based on the individual patient's anatomy.

In illustrative embodiments of the invention, the sound processor unit 502 may include a shotgun microphone 505. Microphones of this type are highly directional and have several technical advantages for the hearing impaired in specific situations (e.g., a cocktail party), but have not been realized in the past as they are typically 6 cm or more long in order to function properly. The flexibility in mounting, and secure positioning of the sound processor 501 on the patient due to magnetic attraction to the implantable portion 203 advantageously allows, from a user and human factor standpoint, such microphones to be utilized.

The shotgun microphone 505 may be, without limitation, 4-7 mm in length and 1-4 mm in diameter. In various embodiments, the shotgun microphone 505 may be mounted near the sound tube 507. The shotgun microphone 505 may be removably attached to the sound processor 501 via, for example, a connecting plug. The shotgun microphone 505 generally may be configured to have a sound inlet at its most distal end from the sound processor 501 and a series of evenly spaced diffusion ports (i.e., small holes or vents) along its length. Operatively coupled to the shotgun microphone's 505 proximal end relative to the sound processor 501, a microphone transducer may be provided that converts acoustic energy into an electrical signal proportional to acoustic sound received at the sound inlet. The transducer may be an electret type microphone transducer.

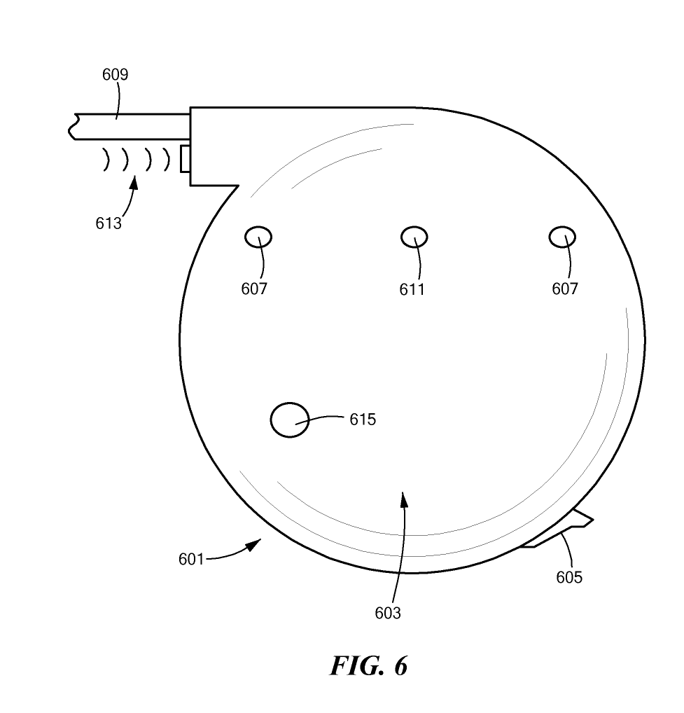

FIG. 6 shows an exemplary sound processor unit 601, in accordance with an embodiment of the invention. The total size of the sound processing unit 601 can be quite small, from as little as 10 mm and as little as 6 mm thick. As the sound processing unit does not have to be custom-made to the patient, the sound processing unit 601 may advantageously be made in mass quantities, resulting in reduced cost. Furthermore, their small size may also reduce costs.

The sound processor 601 includes a housing 603, typically made of plastic, which may be waterproof or water resistant, and, as described above, one or more microphones, illustratively and without limitation, two directional microphone ports 607, an omnidirectional port 611, and a shotgun microphone port 609. The sound processor unit may also includes a sound output port 613 for coupling to a sound tube, and an optional program mode switch 615, which can be used to control what mode the sound processor 601 operates. Various modes include, without limitation, on/off, volume (e.g., loud or quiet) and/or what microphones are activated (e.g., omnidirectional or directional mode). The sound processing unit 601 may also includes a battery door 605, into which a battery may be inserted.

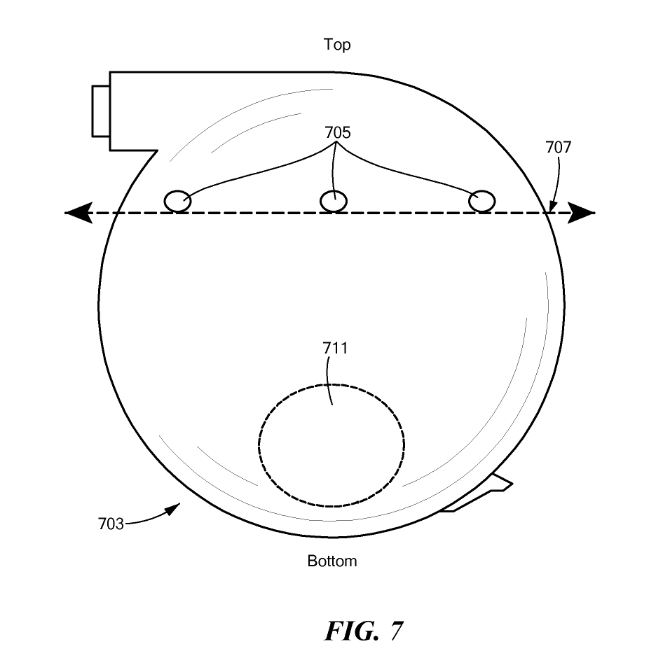

FIG. 7 shows the positioning of a battery 711 within a sound processing unit 703, in accordance with an embodiment of the invention. The battery 711, typically the heaviest component within the sound processing unit 703, is positioned at the bottom (inferior) portion of the sound processing unit 703 when properly positioned on the patient. The placing of the battery at the bottom of the sound processing unit 703 advantageously allows gravity to maintain, or naturally spin and/or otherwise adjust the sound processing unit 703 to, a desired position. A desired position may be such that microphone ports 705 and/or a shotgun microphone are aligned along or parallel to a horizontal or other axis 707.

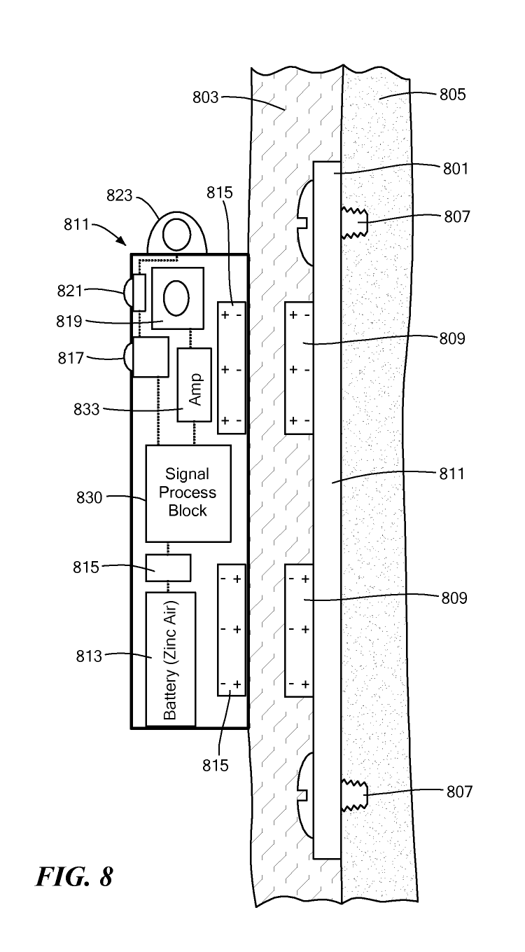

FIG. 8 shows a detailed view of a sound processing unit 811 held into place by an implantable portion 801 of an acoustic hearing aid system, in accordance with an embodiment of the invention. In this embodiment, both the sound processing unit 811 and the implantable portion includes two magnets 815 and 809, respectively, to hold the sound processing unit 811 in place. The magnets 809 are aligned with opposite polarity, as are magnets 815 to ensure proper orientation/rotation of the sound processing unit 811 when operatively coupled to the implantable portion 801. FIG. 8 further illustrates the implantable portion 801 attached under the skin 803 to the skull 805 via screws 807 holding base 811.

Sound processing unit 811 includes a battery 813 positioned at the bottom of the sound processing unit 811, as described above, which provides power to the sound processing unit 811. Battery 813 may be, without limitation, a zinc air battery cell. Sound processing unit 811 may also include program memory 815, a signal processor and an amplifier 833 that, at least in part, are used to amplify and otherwise modify (e.g., filter noise) acoustic sound received by, without limitation, omnimicrophone 817 and shotgun directional microphone 823. The amplified sound is then passed to speaker 819 and output thru a sound tube. A mode switch 817 may also be provided, as discussed above, to set various options within the sound processing unit 811, such as on/off, volume control, and omni/directional settings. The memory 815 may be programmable by, for example, a doctor, to achieve desired signal processing characteristics. Although not shown, various indicators may also be provided on the sound processing unit, that provide status of the sound processing unit, such as, without limitation, power on/off, and battery charged and/or battery low.

In various embodiments, the sound processing unit 811 may be adapted to accommodate and interface with ancillary devices, such as a cell phone. The sound processing unit 811 may receive signals FM, AM or other signals, or may be compatible with Blue Tooth or other compression systems for sound, such as MP3.

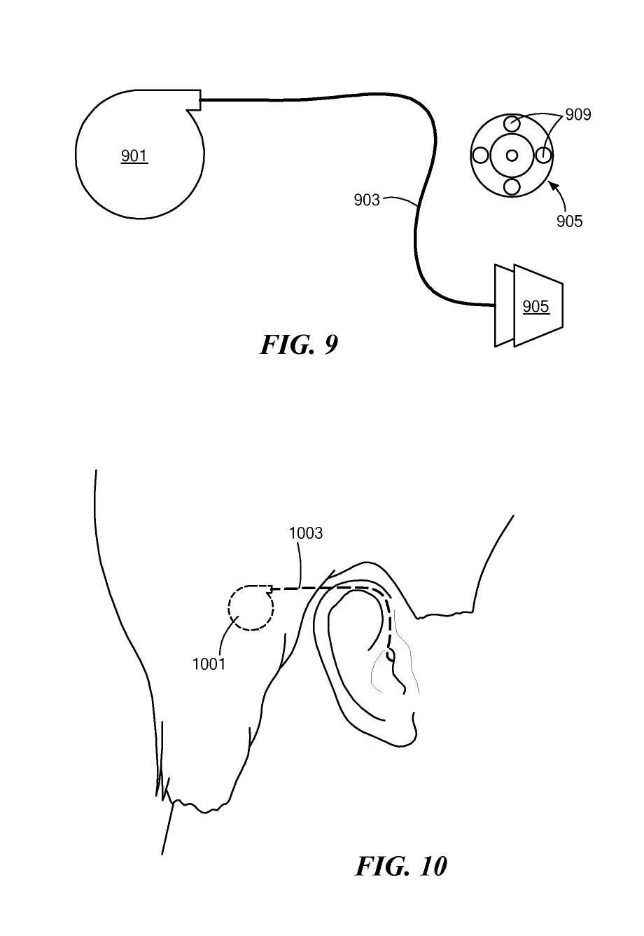

FIG. 9 shows an ear canal insert piece 905, in accordance with an embodiment of the invention. The ear canal insert piece 905 is coupled to sound tube 903, from which it receives received amplified sound coming from sound processing unit 901. Holes 909 in the ear canal insert piece allow ambient noise to pass through. The ear canal insert piece 905 may be positioned on the patient to provide sound to the external ear canal, the middle ear and/or the inner ear.

FIG. 10 shows the sound processing unit 1001 positioned on a patient, in accordance with an embodiment of the invention. More particularly, the sound processing unit 1001 is shown, without limitation, as being worn under the hair post auricualry. The magnets and/or magnetic material of the sound processing unit 1001 are magnetically attracted to the magnets and/or magnetic material of the implantable portion of the acoustic hearing aid system to hold the sound processing unit 1001 in a desired position/orientation, such as under the hair. The sound tube 1003 passes over the Pinna and is introduced into the ear canal via an ear canal insert piece. Compared to conventional BTE, ITE or CIC hearing aids, the sound processing unit 1001 may be advantageously positioned further away from the ear canal and/or ear canal insert piece (see further discussion below).

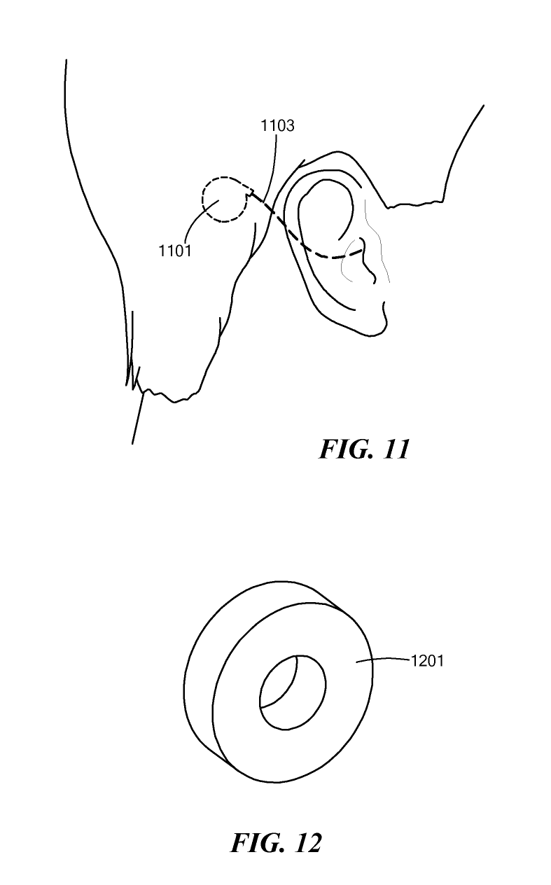

FIG. 11 shows the sound processing unit 1101 positioned on a patient, in accordance with another embodiment of the invention. A small hole with, for example, a bobbin insert 1201, as shown in FIG. 12, is created through the concha of the external ear to allow the sound tube 1103 passage to the ear canal. For many patients, this is more appealing cosmetically compared to the embodiment shown in FIG. 10. The bobbin insert 1201 may be made of, without limitation, titanium.

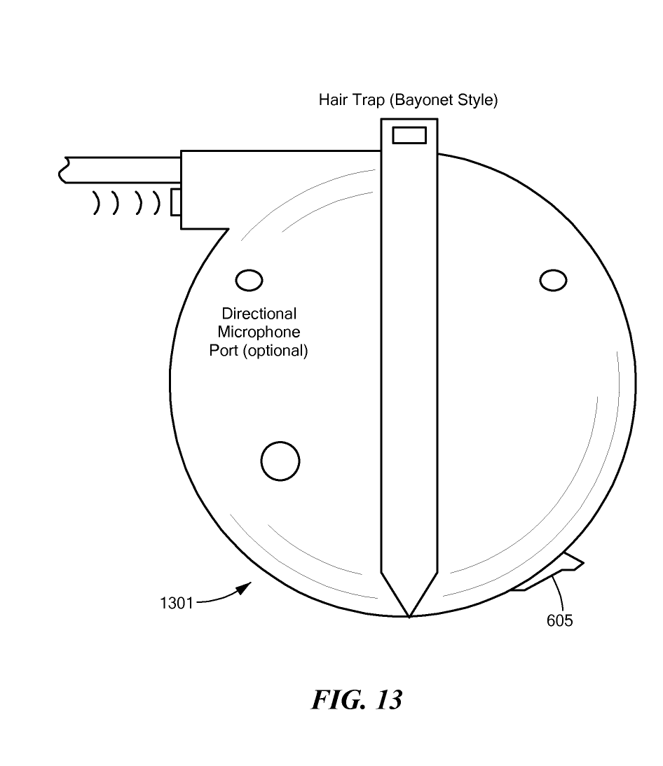

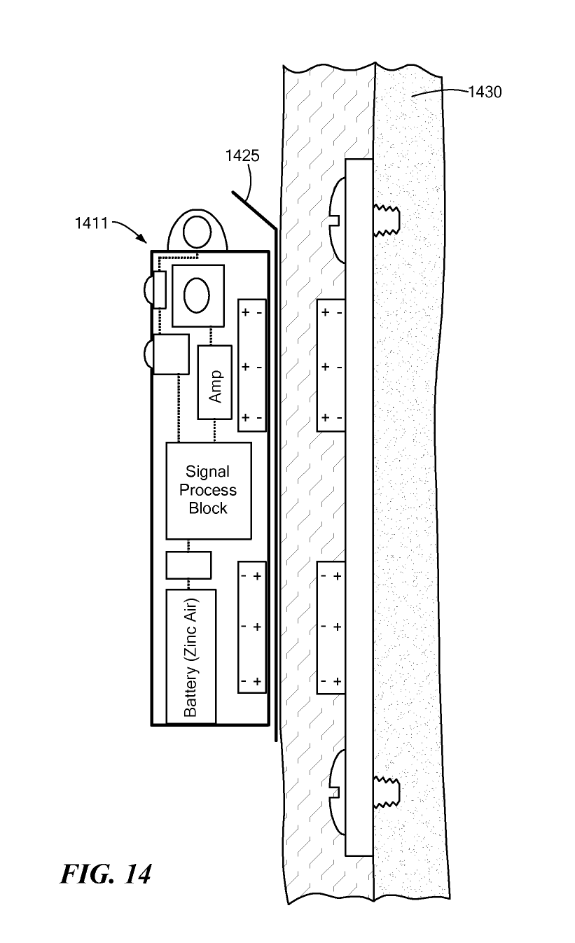

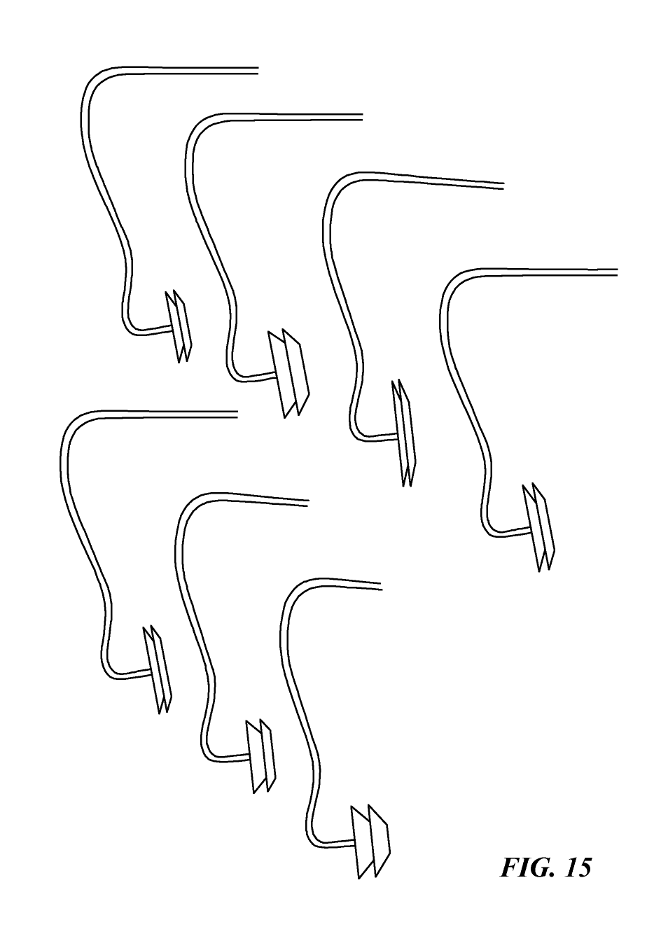

FIG. 13 shows a sound processing unit 1301 that includes a hair trap 1303, in accordance with an embodiment of the invention. The hair trap 1303 traps hair to facilitate placement and maintain proper position of the sound processing unit 1411. The hair trap 1303 may be, without limitation, a clip and/or shaped like a bayonet. FIG. 14 shows a sound processing unit 1411 having a hair trap 1425, wherein the sound processor is secured in position by the implantable portion 1430 of an acoustic hearing aid system in combination with the hair trap 1425, in accordance with an embodiment of the invention. In various embodiments, the hair trap 1425 may be magnetically attracted to the implantable portion 1430, further assisting to secure the sound processing unit 1411 in place. For example, the hair trap 1425 may include a magnet or a magnetic material, such as stainless steel.

FIG. 15 shows various configurations of a sound tube and ear canal insert piece, in accordance with embodiments of the invention. As shown, the sound tube and ear canal insert pieces may be made in several different sizes to accommodate variances in anatomies and implant locations. In various embodiments, the sound tube and/or ear canal insert piece may be patient specific/custom made to fit a particular patient.

Compared to conventional BTE, ITE or CIC configuration, the above-described embodiments of the acoustic hearing aid system advantageously provide reduced feedback, since the sound processing unit, and hence the microphones (i.e., the sound input), of the acoustic hearing aid system can be positioned further away from the sound output. While some feedback may still occur, it will be reduced compared to the prior configurations. The advantage is two-fold. First, there will be a reduction in the annoying feedback “squeal.” Secondly, additional amplification may be provided due to the reduced feedback.

As the sound processing unit may be positioned at a more remote location to the ear, the amount of venting in the ear canal can also be greatly improved, thereby increasing the natural feeling of the ear canal. The occlusion effect which often distorts the perception of the users “own voice” will be reduced.

For many patients, the above-described embodiments of the acoustic hearing aid system will provide improved cosmetics and comfort. Tight fitting parts worn in the ear will be obviated. The sound processing unit may be positioned away from the auricle and Pinna mount that causes irritation and pain in many patients with conventional mounting methodologies (i.e., BTE, CIC, ITE etc. . . . ) Many patients will be able to wear the device for longer periods of time than they are able to tolerate conventional hearing aids. The device may be advantageous for patients living in extreme environments, such as high humidity. Wax intrusion may be reduced, which may also reduce the requirement for routine maintenance.

Although various exemplary embodiment of the invention have been disclosed, it should be apparent to those skilled in the art that various changes and modifications can be made which will achieve some of the advantages of the invention without departing from the true scope of the invention. These and other obvious modifications are intended to be covered by the claims that follow.

What is claimed is:

1. A hearing system for use by a user, the hearing system comprising:
an external portion for placement external the user, the external portion including a sound processing unit for providing amplified acoustic sound to an ear of the user; and
an implantable portion for implantation under the skin of the user, the implantable portion and the sound processing unit having magnetic characteristics such that a magnetic attraction exists there between to retain the sound processing unit in a desired position.

2. The system according to claim 1, wherein at least one of the implantable portion and the sound processing unit includes at least one magnet.

3. The system according to claim 2, wherein the implantable portion includes a first and second magnet positioned so as to have reverse polarity when the implantable portion faces the sound processing unit.

4. The system according to claim 2, wherein one of the implantable portion and the sound processing unit includes stainless steel.

5. The system according to claim 1, wherein the sound processing unit includes a microphone.

6. The system according to claim 5, wherein the microphone is a directional microphone.

7. The system according to claim 6, wherein the directional microphone includes an inlet at a first end of the microphone, and a plurality of evenly spaced diffusion ports along the length of the microphone.

8. The system according to claim 6, wherein said directional microphone is a shotgun microphone.

9. The system according to claim 5, wherein the microphone is removably coupled to the sound processing unit.

10. The system according to claim 5, wherein the sound processing unit includes at least one omnidirectional microphone and at least one directional microphone, and wherein the sound processing unit includes a switch between omnidirectional and directional modes.

11. The system according to claim 1, wherein the external portion includes a sound tube, the sound tube channeling amplified acoustic sound from the sound processing unit to the ear canal.

12. The system according to claim 1, wherein the sound processing unit includes a battery, the battery positioned at the bottom of the sound processing unit such that gravity promotes proper positioning of the sound processing unit.

13. The system according to claim 1, wherein the sound processing unit includes an interface for receiving at least one of a phone signal, FM signal, an AM signal, a blue tooth signal and a MP3 signal.

14. The system according to claim 1, further comprising a hair clip for facilitating placement of the sound processing unit.

15. The system according to claim 14, wherein the hair clip includes at least one of a magnet, stainless steel, and a bayonet.

16. The system according to claim 1, wherein the implanted portion is void of any electronic components.

17. A method of positioning a sound processing unit on a user, the sound processing unit for providing amplified acoustic sound to an ear of the user, the method comprising:
placing the sound processing unit externally to the user such that there is a magnetic attraction between the sound processing unit and an implanted portion of the acoustic sound hearing system that is implanted under the skin of the user, so as to retain the sound processing unit in a desired position.

18. The method according to claim 17, wherein placing the sound processing unit such that there is magnetic attraction between the sound processing unit and an implanted portion includes using a magnet associated with at least one of the implantable portion and the sound processing unit.

19. The method according to claim 18, wherein the implantable portion includes a first and second magnet positioned so as to have reverse polarity when the implantable portion faces the sound processing unit.

20. The method according to claim 17, further comprising converting, by the sound processing unit, an acoustic signal to an electric signal using a microphone.

21. The method according to claim 17, further comprising channeling amplified acoustic sound from the sound processing unit to the ear canal via a sound tube.

22. The method according to claim 17, further comprising positioning a battery at the bottom of the sound processing unit such that gravity promotes proper positioning of the sound processing unit.

23. The method according to claim 17, further comprising interfacing the sound processing unit to receive at least one of a phone signal, FM signal, an AM signal, a blue tooth signal and a MP3 signal.

24. The method according to claim 17, further comprising using a hair clip to facilitate placement of the sound processing unit.

25. The method according to claim 24, wherein the hair clip includes one of a magnet, stainless steel, and a bayonet.

26. The method according to claim 17, wherein the implanted portion is void of any electronic components.
